(19) United States
(12) Patent Application Publication
(10) Pub. No.: US 2026/0151909 A1
(43) Pub. Date: Jun. 4, 2026

(54) ROBOT DRIVING IN SPACE AND CONTROL METHOD THEREOF

(71) Applicant: SAMSUNG ELECTRONICS CO., LTD., Suwon-si (KR)

(72) Inventors: Youngil KOH, Suwon-si (KR); Woojeong KIM, Suwon-si (KR)

(73) Assignee: SAMSUNG ELECTRONICS CO., LTD., Suwon-si (KR)

(21) Appl. No.: 19/391,120

(22) Filed: Nov. 17, 2025

Related U.S. Application Data
(63) Continuation of application No. PCT/KR2025/014280, filed on Sep. 12, 2025.

(30) Foreign Application Priority Data
Dec. 3, 2024 (KR) 10-2024-0177287

(51) Int. Cl. B25J 9/16; B25J 11/00; B25J 13/08; G05D 1/246

(52) U.S. Cl. CPC B25J 9/1666; B25J 9/161; B25J 11/0085; B25J 13/089; G05D 1/2465

(57) ABSTRACT

A robot including: a sensor; a driver; memory storing instructions; and a processor, wherein the instructions, when executed by the processor, cause the robot to: based on identifying an obstacle-dense area within a path based on first sensing data obtained through the sensor while driving in a space, obtain 3D point cloud information based on second sensing data obtained through the sensor; based on identifying that the robot is unable to navigate in the obstacle-dense area, divide the 3D point cloud information into a plurality of planes based on a height of the robot, and identify escape routes for each of the plurality of planes; identify at least one final escape route from among the escape routes by eliminating escape routes that are blocked in any of the plurality of planes; and control the driver to drive based on the at least one final escape route.

### CROSS-REFERENCE TO RELATED APPLICATIONS

This application is a bypass continuation of International Application No. PCT/KR2025/014280, filed on Sep. 12, 2025, which is based on and claims priority to Korean Patent Application No. 10-2024-0177287, filed on Dec. 3, 2024, in the Korean Intellectual Property Office, the disclosures of which are incorporated by reference herein in their entireties.

### BACKGROUND

### 1. Field

The disclosure relates to a robot driving in a space, and a control method thereof.

### 2. Description of Related Art

Recently, development of technologies for a robot that is arranged in a specific space and provides services to users is actively going on.

A robot cleaner may perform a cleaning job as it drives in a space while avoiding obstacles by using a sensor and software.

The aforementioned information may be provided as related art aimed at promoting understanding of the disclosure. Any argument or determination may not be raised regarding which of the aforementioned contents can be applied as prior art related to the disclosure.

### SUMMARY

According to an aspect of the disclosure, a robot includes: a sensor; a driver; memory storing instructions; and at least one processor including processing circuitry, wherein the instructions, when executed by the at least one processor individually or collectively, cause the robot to: based on identifying an obstacle-dense area within a forward path based on first sensing data obtained through the sensor while driving in a space, obtain three-dimensional (3D) point cloud information based on second sensing data obtained through the sensor, based on identifying that the robot is unable to navigate in the obstacle-dense area, divide the 3D point cloud information into a plurality of planes based on a height of the robot, and identify one or more escape routes for each of the plurality of planes, identify at least one final escape route, from among the one or more escape routes, by eliminating escape routes from the one or more escape routes that are blocked in any of the plurality of planes, and control the driver to drive based on the at least one final escape route.

The instructions, when executed by the at least one processor individually or collectively, may further cause the robot to: equally divide the height of the robot by a specific interval, and divide the 3D point cloud information into the plurality of planes corresponding to the equally divided heights.

The instructions, when executed by the at least one processor individually or collectively, may further cause the robot to: based on identifying that the robot is unable to navigate in the obstacle-dense area, obtain the second sensing data through the sensor by performing a primitive motion, and obtain the 3D point cloud information based on the second sensing data.

The primitive motion may include at least one of a rotating-in-place motion or a forward-backward moving motion.

The instructions, when executed by the at least one processor individually or collectively, may further cause the robot to eliminate escape routes from the one or more escape routes by: identifying at least one first escape route on a lowermost plane among the plurality of planes, and updating the at least one first escape route by identifying at least one second escape route on a plane directly above the lowermost plane, among the plurality of planes and eliminating from the at least one first escape route an escape route that does not coincide with the at least one second escape route; and the instructions, when executed by the at least one processor individually or collectively, may further cause the robot to control the driver to drive based on the updated first escape route.

The instructions, when executed by the at least one processor individually or collectively, may further cause the robot to eliminate escape routes from the one or more escape routes by: identifying at least one third escape route on an uppermost plane among the plurality of planes, and updating the at least one third escape route by identifying at least one fourth escape route on a plane directly below the uppermost plane, among the plurality of planes, and eliminating from the at least one third escape route an escape route that does not coincide with the at least one fourth escape route. and the instructions, when executed by the at least one processor individually or collectively, may further cause the robot to control the driver to drive based on the updated third escape route.

The instructions, when executed by the at least one processor individually or collectively, may further cause the robot to: based on identifying the at least one final escape route, identify a priority of each of the at least one final escape route based on at least one of a location of a target point, an escape distance, or an escape time, and control the driver to drive according to the at least one final escape route with the highest identified priority.

The instructions, when executed by the at least one processor individually or collectively, may further cause the robot to: based on the robot failing to reach a short term target point within a specific time after entering the obstacle-dense area or the robot remaining within a specific area during a predetermined time or longer, identify that the robot is unable to navigate in the obstacle-dense area.

The instructions, when executed by the at least one processor individually or collectively, may further cause the robot to: after escaping the obstacle-dense area, set the obstacle-dense area as an area where re-entry is prohibited.

The instructions, when executed by the at least one processor individually or collectively, may further cause the robot to: initialize the accumulated 3D point cloud information after escaping the obstacle-dense area.

According to an aspect of the disclosure, a method of controlling a robot includes: based on identifying an obstacle-dense area within a forward path based on first sensing data obtained while driving in a space, obtaining three-dimensional (3D) point cloud information based on second sensing data; based on identifying that the robot is unable to navigate in the obstacle-dense area, dividing the 3D point cloud information into a plurality of planes based on a height of the robot, and identifying one or more escape routes for each of the plurality of planes; identifying at least one final escape route, from among the one or more escape routes, by eliminating escape routes from the one or more escape routes that are blocked in any of the plurality of planes; and controlling a driver of the robot to drive based on the at least one final escape route.

The identifying the one or more escape routes may include: equally dividing the height of the robot by a specific interval; and dividing the 3D point cloud information into the plurality of planes corresponding to the equally divided heights.

The method may further include: based on identifying that the robot is unable to navigate in the obstacle-dense area, obtaining the second sensing data by performing a primitive motion; and obtaining the 3D point cloud information based on the second sensing data.

The primitive motion may include at least one of a rotating-in-place motion or a forward-backward moving motion.

The method may further include: based on identifying the at least one final escape route, identifying a priority of each of the at least one final escape route based on at least one of a location of a target point, an escape distance, or an escape time, and controlling the driver to drive according to the at least one final escape route with the highest identified priority.

The method may further include: based on the robot failing to reach a short term target point within a specific time after entering the obstacle-dense area or the robot remaining within a specific area during a predetermined time or longer, identifying that the robot is unable to navigate in the obstacle-dense area.

According to an aspect of the disclosure, a non-transitory computer-readable medium stores computer instructions which, when executed by at least one processor of a robot, cause the robot to execute a control method including: based on identifying an obstacle-dense area within a forward path based on first sensing data obtained while driving in a space, obtaining three-dimensional (3D) point cloud information based on second sensing data; based on identifying that the robot is unable to navigate in the obstacle-dense area, dividing the 3D point cloud information into a plurality of planes based on a height of the robot, and identifying one or more escape routes for each of the plurality of planes; identifying at least one final escape route, from among the one or more escape routes, by eliminating escape routes from the one or more escape routes that are blocked in any of the plurality of planes; and controlling the robot to drive based on the at least one final escape route.

With regard to the method executed by the at least on processor based on the instructions stored in the non-transitory computer readable medium, the identifying the one or more escape routes may include: equally dividing the height of the robot by a specific interval; and dividing the 3D point cloud information into the plurality of planes corresponding to the equally divided heights.

With regard to the method executed by the at least on processor based on the instructions stored in the non-transitory computer readable medium, the method may further include: based on identifying that the robot is unable to navigate in the obstacle-dense area, obtaining the second sensing data by performing a primitive motion; and obtaining the 3D point cloud information based on the second sensing data.

With regard to the method executed by the at least on processor based on the instructions stored in the non-transitory computer readable medium, the primitive motion may include at least one of a rotating-in-place motion or a forward-backward moving motion.

According to an aspect of the disclosure, a robot includes: a sensor; a driver; memory storing instructions; and at least one processor configured to execute the instructions, wherein the instructions, when executed by the at least one processor individually or collectively, cause the robot to: identifying an area within a forward path of the robot as an obstacle-dense area based on first sensing data obtained through the sensor while driving in a space, wherein the area includes a number of obstacles within a predetermined distance of one another and the number of obstacles exceeds a predetermined threshold, based on identifying the obstacle-dense area, obtain three-dimensional (3D) point cloud information based on second sensing data obtained through the sensor, based on identifying that a maneuverability of the robot within the obstacle-dense area is less than a predetermined threshold, divide the 3D point cloud information into a plurality of planes based on a height of the robot, and identify one or more escape routes for each of the plurality of planes, identify at least final one escape route, from among the one or more escape routes, by eliminating escape routes from the one or more escape routes that are blocked in any of the plurality of planes, and control the driver to drive based on the at least one final escape route.

### BRIEF DESCRIPTION OF THE DRAWINGS

The above and other aspects and characteristics of specific embodiments of the disclosure will become clearer from the following detailed description described with reference to the accompanying drawings, in which:

FIG. 1A is a diagram for illustrating a situation where a robot is trapped according to an embodiment;

FIG. 1B is a diagram for illustrating a situation where a robot is trapped according to an embodiment;

FIG. 2 is a block diagram illustrating a configuration of a robot according to an embodiment;

FIG. 3 is a flow chart for illustrating an example of a control method of a robot according to an embodiment;

FIG. 4A is a diagram for illustrating a method of identifying escape routes for each of a plurality of planes according to an embodiment;

FIG. 4B is a diagram for illustrating a method of identifying escape routes for each of a plurality of planes according to an embodiment;

FIG. 5 is a diagram for illustrating a method of identifying a final escape route based on escape routes for each plane according to an embodiment;

FIG. 6 is a diagram for illustrating a method of identifying a final escape route based on escape routes for each plane according to an embodiment;

FIG. 7A is a diagram for illustrating a scenario after escaping an obstacle-dense area according to an embodiment;

FIG. 7B is a diagram for illustrating a scenario after escaping an obstacle-dense area according to an embodiment;

FIG. 7C is a diagram for illustrating a scenario after escaping an obstacle-dense area according to an embodiment; and

FIG. 8 is a flow chart for illustrating an example of a method of escaping obstacles according to an embodiment.

### DETAILED DESCRIPTION

Hereinafter, embodiments of the disclosure will be described in detail with reference to the accompanying drawings.

With regard to terms used in the embodiments of the disclosure, general terms that are currently used widely were selected when possible in consideration of the functions described in the disclosure. However, the meaning of the terms used herein may vary depending on the intention of those skilled in the art who work in the pertinent field or previous court decisions, emergence of new technologies, etc. Further, in particular cases, there may be terms that are designated by the applicant, and in such cases, the meaning of the terms will be described in detail in the relevant descriptions in the disclosure. Accordingly, the terms used in the disclosure should be defined based on the meaning of the terms and the overall content of the disclosure, but not just based on the terms alone.

Also, in this specification, expressions such as “have,” “may have,” “include,” and “may include” denote the existence of such characteristics (e.g., elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may describe various elements regardless of any order and/or degree of importance. Also, such expressions are used only to distinguish one element from another element, and are not intended to limit the elements.

The description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

Also, singular expressions include plural expressions, unless defined obviously differently in the context. In addition, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the embodiments of the disclosure, “a module” or “a part” may perform at least one function or operation, and may be implemented as hardware or software, or as a combination of hardware and software. Also, a plurality of “modules” or “parts” may be integrated into at least one module and implemented as at least one processor, excluding “a module” or “a part” that needs to be implemented as specific hardware.

Also, in the disclosure, the term “user” may refer to a person who uses a robot or a device using a robot (e.g., an artificial intelligence robot).

In addition, various elements and areas in the drawings were illustrated schematically. Accordingly, the technical idea of the disclosure is not limited by the relative sizes or intervals illustrated in the accompanying drawings.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereinafter, an embodiment of the disclosure will be described in more detail with reference to the accompanying drawings.

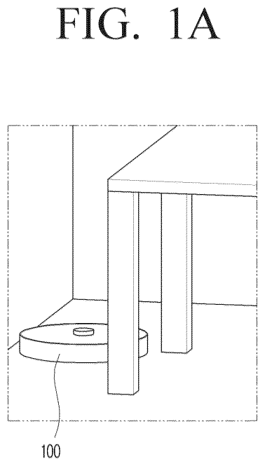

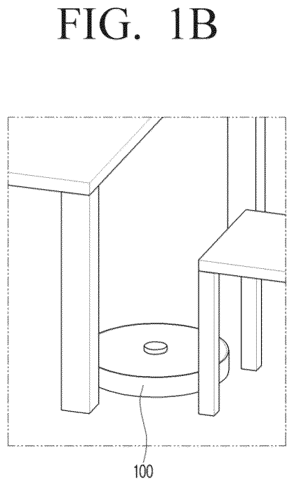

FIG. 1A and FIG. 1B are diagrams for illustrating a situation where a robot is trapped according to an embodiment.

According to an embodiment, a robot 100 may be implemented as a robot cleaner. A robot cleaner is a home appliance that automatically cleans the floor, and may recognize a space by using a sensor and artificial intelligence technology, and suck dust and pollutants. However, the disclosure is not limited thereto, and the robot 100 may be implemented as various types of service robots such as a delivery robot, a guide robot, a serving robot, and/or a companion robot. However, in the disclosure, explanation will be described by assuming a case wherein the robot 100 is implemented as a robot cleaner (or a cleaning robot) for the convenience of explanation.

According to an embodiment, as illustrated in FIG. 1A and FIG. 1B, a situation where a robot 100 becomes trapped (also referred to herein as a “trapped situation”) may occur because of an obstacle or a specific environmental condition. For example, a trapped situation may occur frequently in an obstacle-dense area such as a space between a dining table and a chair, and a space between a wall and a chair. In this case, the robot 100 may have to end a job after reattempting escape or egress, or direct intervention by a user may be needed, for example in a situation where the robot 100 repeats unsuccessful attempts to drive or move in a space where it is difficult for the robot 100 to determine 3D shape information as it performs driving based on a 2D LiDAR sensor.

Accordingly, hereinafter, various embodiments wherein the robot 100 can escape an obstacle-dense area through planning of a sequential route for each plane in a 3D space when a trapped situation of the robot 100 in an obstacle-dense area occurs will be explained.

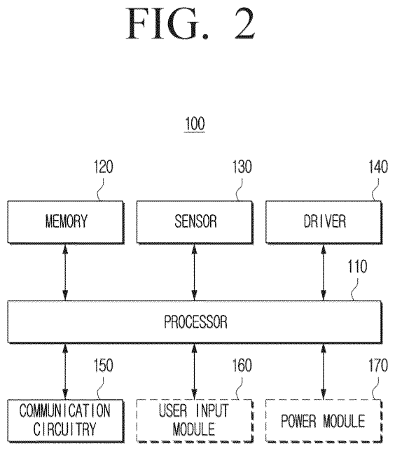

FIG. 2 is a block diagram illustrating a configuration of a robot according to an embodiment.

According to FIG. 2, the robot 100 may include at least one processor 110 (also referred to herein as “the processor”), memory 120, a sensor 130, a driver 140, a communication circuit 150, a user input module 160, and a power module 170. The at least one processor 110, the memory 120, the sensor 130, the driver 140, the communication circuit 150, the user input module 160, and the power module 170 may be electronically and/or operably coupled with each other by electronic components such as a communication bus.

According to an embodiment, operative coupling of the hardware of the robot 100 may mean that direct connection or indirect connection between the hardware was established via wire or wirelessly, such that the second hardware is controlled by the first hardware among the hardware. While the embodiment is illustrated based on different blocks, the disclosure is not limited thereto, and some of the hardware in FIG. 2 (e.g., the at least some of the processor 110, the memory 120, the communication circuit 150, the driver 140, the sensor 130, the user input module 160, and the power module 170) may be included in a single integrated circuit such as a system on a chip (SoC). The types and/or the number of the hardware included in the robot 100 are not limited to what is illustrated in FIG. 2. For example, the robot 100 may include only some of the hardware components illustrated in FIG. 2.

The processor 110 of the robot 100 according to an embodiment may include hardware for processing data based on at least one instruction. The hardware for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). The number of the processor 110 may be one or more. For example, the processor 110 may have a structure of a multi-core processor such as a dual core, a quad core, or a hexa core.

The processor 110 may control the operations of the robot 100 by executing the instructions stored in the memory 120. For example, the processor 110 may correspond to a plurality of processors that divide a plurality of operations among the processors, and that individually or collectively perform the operations.

A central processing unit (CPU) is a generic-purpose processor that can perform not only general operations but also artificial intelligence operations, and it can effectively execute a complex program through a multilayer cache structure. A CPU is advantageous for a serial processing method that enables a systemic linking between the previous calculation result and the next calculation result through sequential calculations. A generic-purpose processor is not limited to the aforementioned examples excluding cases wherein it is specified as the aforementioned CPU.

A graphic processing unit (GPU) is a processor for mass operations such as a floating point operation used for graphic processing, etc., and it can perform mass operations in parallel by massively integrating cores. In particular, a GPU may be advantageous for a parallel processing method such as a convolution operation, etc. compared to a CPU. Also, a GPU may be used as a co-processor for supplementing the function of a CPU. A processor for mass operations is not limited to the aforementioned examples excluding cases wherein it is specified as the aforementioned GPU.

A neural processing unit (NPU) is a processor specialized for an artificial intelligence operation using an artificial neural network, and it can implement each layer constituting an artificial neural network as hardware (e.g., silicon). Here, the NPU is designed to be specialized according to the required specification of a company, and thus it has a lower degree of freedom compared to a CPU or a GPU, but it can effectively process an artificial intelligence operation required by the company. As a processor specialized for an artificial intelligence operation, an NPU may be implemented in various forms such as a tensor processing unit (TPU), an intelligence processing unit (IPU), and a vision processing unit (VPU). An artificial intelligence processor is not limited to the aforementioned examples excluding cases wherein it is specified as the aforementioned NPU.

The memory 120 of the robot 100 according to an embodiment may include hardware components for storing data and/or instructions that are input into and/or output from the processor 110. The memory 120 may be implemented in a form of memory embedded in the robot 100, or implemented in a form of memory that can be attached to or detached from the robot 100 according to the usage of stored data. For example, in the case of data for operating the robot 100, the data may be stored in memory embedded in the robot 100, and in the case of data for an extended function of the robot 100, the data may be stored in memory that can be attached to or detached from the robot 100. In the case of memory embedded in the robot 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the robot 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

Inside the memory 120 of the robot 100 according to an embodiment, one or more instructions indicating operations and/or actions that the processor 110 will perform for data may be stored. A set of one or more instructions may be referred to as firmware, an operating system, a process, a routine, a sub-routine, and/or an application. For example, the robot 100 and/or the processor 110 may perform various operations when a set of a plurality of instructions distributed in a form of an operating system, firmware, a driver, and/or an application is executed. Hereinafter, the feature that an application was installed on the robot 100 may mean that one or more instructions provided in the form of an application were stored in the memory 120 of the robot 100, and that the one or more applications were stored in a format that is executable by the processor 110 of the robot 100 (e.g., a file having an extension designated by the operating system of the robot 100).

The at least one processor 110 performs control to process input data according to predefined operation rules or an artificial intelligence (AI) model stored in the memory 120. The predefined operation rules or the AI model are characterized in that they are made through learning. Being made through learning means that predefined operation rules or an AI model having desired characteristics are made by applying a learning algorithm to a plurality of training data. Such learning may be performed in a device itself wherein artificial intelligence is performed according to the disclosure, or through a separate server/system.

An AI model may consist of a plurality of neural network layers. At least one layer has at least one weight value, and performs an operation of the layer through the operation result of the previous layer and at least one defined operation. As examples of a neural network, there are a convolutional neural network (CNN), a recurrent neural network (RNN), a deep neural network (DNN), a restricted Boltzmann Machine (RBM), a deep belief network (DBN), a bidirectional recurrent deep neural network (BRDNN), deep Q-networks, and a transformer, but the neural network in the disclosure is not limited to the aforementioned examples excluding specified cases.

A learning algorithm is a method of training a specific subject device (e.g., a robot) by using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

The sensor 130 of the robot 100 according to an embodiment may sense various types of information. The sensor 130 may be implemented as various types of sensors. For example, the sensor 130 may include at least one sensor among a camera, a Time of Flight (ToF) sensor, an ultrasonic sensor, a radio detection and ranging (RADAR) sensor, a photodiode sensor, a proximity sensor, a passive infrared (PIR) sensor, a pin hole sensor, a pin hole camera, an infrared human body detection sensor, a complementary metal oxide semiconductor (CMOS) image sensor, a heat detection sensor, an optical sensor, or a motion detection sensor. For example, the camera may include at least one of a general (or basic) camera or an ultra wide angle camera.

The sensor 130 may include a touch sensor that has a form such as touch film, a touch sheet, and a touch pad, and detects touching operations.

The sensor 130 may include at least one of a camera, a microphone, a CO₂ sensor, or a barometric pressure sensor. The camera may convert a photographed image into an electrical signal, and generate image data based on the converted signal. For example, the camera may include at least one of a general (or basic) camera, a depth camera, or an ultra wide angle camera. The microphone is a component for receiving input of a user voice or other sounds, and converting them into audio data. The CO₂ sensor is a sensor for measuring the concentration of carbon dioxide. The barometric pressure sensor is a sensor for sensing the air pressure of the surroundings.

The sensor 130 may further include at least one sensor that can sense the ambient illumination, the ambient temperature, and an incident direction of light. In this case, the sensor 130 may be implemented as an illumination sensor, a temperature detection sensor, a light quantity sensing layer, and a camera.

The sensor 130 may further include at least one of an acceleration sensor (or a gravity sensor), a geomagnetic sensor, or a gyro sensor. For example, the acceleration sensor may be a 3-axis acceleration sensor. The 3-axis acceleration sensor may measure gravitational acceleration for each axis, and provide the raw data to the processor 110. The geomagnetic sensor or the gyro sensor may be used in obtaining posture information. Here, the posture information may include at least one of roll information, pitch information, or yaw information.

The driver 140 of the robot 100 according to an embodiment is a device that can make the robot 100 drive. The driver 140 may adjust the driving direction and the driving speed according to control by the processor 110, and the driver 140 according to an embodiment may include a power generation device (e.g., a gasoline engine, a diesel engine, a liquefied petroleum gas (LPG) engine, an electric motor, etc. according to the used fuel (or the energy source)) that generates power for the robot 100 to drive, a steering device (e.g., manual steering, hydraulics steering, electronic control power steering (EPS), etc.) for adjusting a driving direction, a driving device (e.g., wheels, a propeller, etc.) making the robot 100 drive according to power, etc. Here, the driver 140 may be implemented while being modified according to the driving type (e.g., a wheel type, a walking type, a flying type, etc.) of the robot 100.

The communication circuit 150 of the robot 100 according to an embodiment may include hardware for supporting transmission and/or reception of electric signals between the robot 100 and an external device (e.g., a server). For example, the communication circuit 150 may perform communication with an external device, an external storage medium (e.g., a USB memory), an external server (e.g., a webhard), etc., through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc. According to an embodiment, the communication circuit 150 may perform communication with another robot, an external server, a remote control device, etc.

The user input module 160 of the robot 100 according to an embodiment may be implemented as a device such as a button, a touch pad, and/or a touch screen, etc. that can perform both of the aforementioned display function and a manipulation input function.

The power module 170 of the robot 100 according to an embodiment may be a module that supplies energy for the robot 100 to operate. For example, the power module 170 may be supplied with power through at least one of a battery, a fuel cell, energy harvesting, or wireless power, and supply energy for the robot 100 to operate. For example, the power module 170 may convert an output voltage of the battery into a voltage required by each component of the robot through a voltage converter, and monitor the state of the battery by using a battery management system, and prevent overcharge and over-discharge.

Other than the above, the robot 100 may further include a speaker, a microphone, a display, etc. depending on implementation examples. For example, the speaker may be a component that outputs not only various types of audio data but also various types of notification sounds or voice messages, etc.

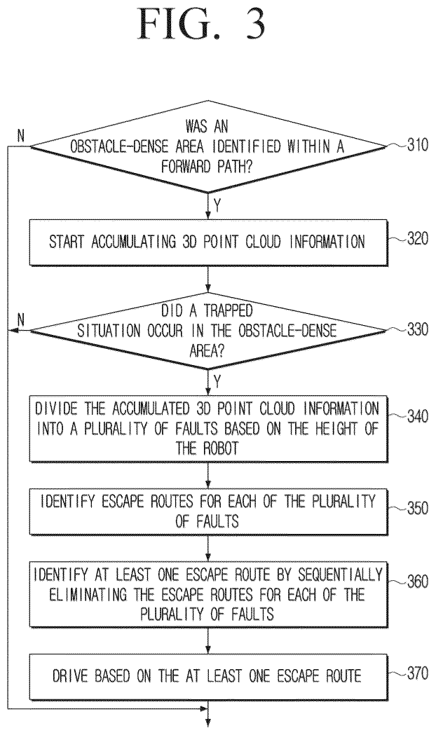

FIG. 3 is a flow chart for illustrating an example of a control method of a robot according to an embodiment.

In the embodiments described below, each operation may be performed sequentially, but they are not necessarily performed sequentially. For example, the order of each operation may be changed, or at least two operations may be performed in parallel.

According to an embodiment, the operations 310 to 350 may be understood to be performed in the processor 110 of the robot 100.

According to an embodiment, the robot 100 may be implemented as a robot cleaner. However, the disclosure is not limited thereto, and the robot 100 may be implemented as various types of service robots such as a delivery robot, a guide robot, a serving robot, and/or a companion robot.

According to FIG. 3, in the operation 310, the robot 100 according to an embodiment may identify whether an obstacle-dense area exists within a forward path while driving in a space.

According to an embodiment, a driving space of a robot may be a physical area wherein the robot can perform a job while moving, and a range thereof. For example, a driving space of a robot may include various spaces such as at least one of a home, an office, or a store.

According to an embodiment, the robot 100 may have stored map data corresponding to spaces where the robot may operate, and may drive in a space by performing path planning based on the map data. According to an embodiment, the map data may be various types of map data such as a traversability map, a distance map, etc.

According to an embodiment, the robot 100 may obtain a free space map based on simultaneous localization and mapping (SLAM). Here, the reference to utilization of SLAM assumes the robot 100 is in the operating location at the time the map is generated. For example, the robot 100 may obtain a free space map based on data obtained through the sensor 130. According to an embodiment, the robot 100 may identify the location of the robot 100, and obtain a free space map by using various sensors provided in the robot 100 such as a camera, a LiDAR sensor, an infrared sensor, an ultrasonic sensor, etc. Here, the free space map may be in a form divided into at least one of an occupied space, a free space, or an unknown space.

According to an embodiment, the robot 100 may obtain a distance map based on information on a free space included in a free space map and information obtained through the sensor 130 (e.g., a LiDAR sensor) while the robot 100 is driving. Here, the distance map may include information such as distances to obstacles and probability values of obstacles. According to an embodiment, the processor 110 may drive in a space based on the distance map.

According to an embodiment, the robot 100 may determine whether an obstacle-dense area exists within a forward path based on first sensing data. For example, an obstacle-dense area may be a space including multiple obstacles, or a space wherein obstacles are concentrated and thus a path on which the robot 100 can move is narrow, or an interval between the robot 100 and an object (e.g., a stationary object or a fixed object) is very limited.

For example, the first sensing data may include sensing data obtained through a light detection and ranging (LiDAR) sensor, but the disclosure is not limited thereto, and the first sensing data may include sensing data obtained through at least one sensor among an ultrasonic sensor, an infrared sensor, and a camera. For example, data obtained through the LiDAR sensor may be data wherein distances from objects were calculated by measuring the time between emission of a laser and detection of its reflected return.

According to an embodiment, the robot 100 may determine whether an obstacle-dense area exists based on at least one of point density or an occupancy grid map of cloud point data obtained through the LiDAR sensor. According to an embodiment, the robot 100 may measure distances from all obstacles that exist on the front, and if several obstacles exist in shorter than or equal to a specific distance, the robot 100 may determine the area as an obstacle-dense area. According to an embodiment, if there are few empty spaces in a field of view (FOV) of the sensor 130, the robot 100 may determine the area as an obstacle-dense area. According to an embodiment, the robot 100 may identify clusters of obstacles based on a clustering algorithm (e.g., a K-Means algorithm or a DBSCAN algorithm), and if there are number of clusters exceeding a predetermined threshold, and they are distributed to be close to one another, the robot 100 may determine the area as an obstacle-dense area.

If an obstacle-dense area is identified within the forward path in the operation 310:Y, the robot 100 according to an embodiment may start accumulating 3D point cloud information in the operation 320.

According to an embodiment, the robot 100 may start accumulating 3D point cloud information based on second sensing data.

According to an embodiment, the second sensing data may be at least partially identical to, or different from the first sensing data. According to an embodiment, the second sensing data may be data obtained through at least one of a LiDAR sensor, a depth camera, or an RGB-D camera. The 3D point cloud may be a set of data points expressed as a 3D coordinate (x, y, z). For example, each point may indicate a location on a surface of an object.

According to an embodiment, the robot 100 may start accumulating 3D point cloud information obtained through at least one of a LiDAR sensor, a depth camera, or an RGB-D camera. For example, the robot 100 may start accumulating 3D point cloud information by correcting differences in the locations and the orientations among each data based on the correct location and direction of the sensor. For example, the robot 100 may start accumulating 3D point cloud information based on at least one of an iterative closest point (ICP) or a normal distributions transform (NDT). For example, the ICP may be a method of minimizing errors by repeatedly performing matching among point clouds, and the NDT may be a method of converting points into probability distribution and matching them. According to an embodiment, the robot 100 may generate an integrated 3D model by accumulating the 3D point cloud information.

In the operation 330, the robot 100 according to an embodiment may identify whether a trapped situation occurs in the obstacle-dense area.

According to an embodiment, in case the robot 100 failed to reach a short term target point within a specific time after entering the obstacle-dense area, the robot 100 may identify that a trapped situation occurred. For example, the robot 100 may identify whether it failed to reach a short term target point within a specific time based on location information and time counting information according to a SLAM technology.

According to an embodiment, if the robot 100 identifies that it remains within a specific area during a predetermined time or longer, it may identify that a trapped situation has occurred. For example, the robot 100 may identify whether it remains within a specific area during a predetermined time or longer based on location information and time counting information according to a SLAM technology.

If it is identified that a trapped situation has occurred in the obstacle-dense area in the operation 330:Y, in the operation 340, the robot 100 according to an embodiment may divide the accumulated 3D point cloud information into a plurality of planes based on the height of the robot 100.

According to an embodiment, the robot 100 may equally divide the height of the robot 100 by a specific interval, and divide the accumulated 3D point cloud information into a plurality of planes corresponding to the equally divided heights. For example, the specific interval may be a value that was set in advance when the robot 100 was manufactured. For example, the specific interval may be a value that can be set and/or changed by a user input.

According to an embodiment, if a trapped situation occurs in the obstacle-dense area, the robot 100 may obtain the second sensing data by performing a primitive motion, and additionally accumulate the 3D point cloud information obtained based on the obtained second sensing data. According to an embodiment, the robot 100 may equally divide the height of the robot 100 by a specific interval, and divide the additionally accumulated 3D point cloud information into a plurality of planes corresponding to the equally divided heights. The primitive motion may be a basic unit operation that constitutes a complex movement in robotics or motion control. For example, a primitive motion may indicate one basic operation.

According to an embodiment, the primitive motion may include at least one of a rotating-in-place motion or a forward-backward moving motion. According to an embodiment, if a trapped situation occurs in the obstacle-dense area, the robot 100 may start accumulating 3D point cloud information by obtaining the second sensing data by performing a rotating-in-place motion. According to an embodiment, if a trapped situation occurs in the obstacle-dense area, the robot 100 may start accumulating 3D point cloud information corresponding to information on a blocked field of view by obtaining the second sensing data by performing a forward-backward moving motion.

In the operation 350, the robot 100 according to an embodiment may identify escape routes for each of the plurality of planes.

According to an embodiment, the robot 100 may identify escape routes corresponding to each of the plurality of planes based on the 3D cloud information corresponding to each of the plurality of planes. For example, the robot 100 may identify escape routes corresponding to each of the plurality of planes based on the 3D cloud information that was additionally accumulated by performing a primitive motion. For example, the robot 100 may identify escape routes by determining a movable direction by analyzing obstacle distribution based on the 3D cloud information corresponding to each of the plurality of planes.

In the operation 360, the robot 100 according to an embodiment may identify at least one escape route based on the escape routes for each of the plurality of planes. According to an embodiment, the robot 100 may identify at least one escape route by sequentially eliminating the escape routes for each of the plurality of planes. For example, the robot 100 may identify a final escape route by sequentially identifying the escape routes for each of the plurality of planes in one direction, and eliminating escape routes that do not coincide. For example, the one direction may include at least one of an upper direction from the lowermost plane or a lower direction from the uppermost plane among the plurality of planes.

According to an embodiment, the robot 100 may identify at least one first escape route on the first plane which is the lowermost plane among the plurality of planes. Then, the robot 100 may identify at least one second escape route on the second plane which is the next plane in the upper direction from the lowermost plane. Then, the robot 100 may update the first escape route by eliminating a route that does not coincide with the at least one second escape route in the at least one first escape route. Then, the robot 100 may finally update the first escape route through an operation of eliminating a route for all the planes including the remaining planes.

According to an embodiment, the robot 100 may identify at least one third escape route on the third plane which is the uppermost plane among the plurality of planes. Then, the robot 100 may identify at least one fourth escape route on the fourth plane which is the next plane in the lower direction from the uppermost plane. Then, the robot 100 may update the third escape route by eliminating a route that does not coincide with the at least one second escape route in the at least one third escape route. Then, the robot 100 may finally update the third escape route through an operation of eliminating a route for all the planes including the remaining planes.

In the operation 370, the robot 100 according to an embodiment may drive based on at least one escape route.

According to an embodiment, the robot 100 may drive out of the obstacle-dense area based on the finally updated first escape route or third escape route in the operation 360.

According to an embodiment, if a plurality of escape routes are finally identified, the robot 100 may identify priorities of the plurality of escape routes based on at least one of a location of a target point, an escape distance, or an escape time. According to an embodiment, the robot 100 may identify priorities of the plurality of escape routes based on at least one of a location of a target point, an escape distance, or an escape time according to service types. In this case, when the priorities of the plurality of escape routes are identified, the robot 100 may perform escape driving according to an escape route having the highest priority among the plurality of escape routes.

For example, the robot 100 may perform escape driving according to an escape route wherein the location of the next target point is the shortest among the plurality of escape routes.

For example, the robot 100 may perform escape driving according to an escape route wherein the escape distance is the shortest among the plurality of escape routes.

For example, the robot 100 may perform escape driving according to an escape route wherein the escape time is the shortest among the plurality of escape routes.

For example, the robot 100 may identify the priorities of the plurality of escape routes based on weight values corresponding to at least two among a location of a target point, an escape distance, and an escape time. For example, the robot 100 may obtain a first value by applying a first weight to a distance difference between a location of a target point and the current location, obtain a second value by applying a second weight to an escape distance, obtain a third value by applying a third weight to an escape time, and perform escape driving according to an escape route that has the smallest value among values of summing up the first value, the second value, and the third value.

According to an embodiment, when the robot 100 escapes the obstacle-dense area, the robot 100 may return to the original driving path or resume driving after re-searching a moving path.

According to an embodiment, the robot 100 may initialize the accumulated 3D point cloud information after escaping the obstacle-dense area. For example, the robot 100 may initialize the accumulated 3D point cloud information by deleting the 3D point cloud information accumulatively stored in the memory 120. Accordingly, the robot 100 can secure memory efficiency.

According to an embodiment, the robot 100 may set the obstacle-dense area as an area wherein re-entry is impossible after escaping the obstacle-dense area. For example, the robot 100 may exclude the obstacle-dense area set as an area wherein re-entry is impossible from a driving path. For example, if obstacles in the obstacle-dense area are removed afterwards, and the area is identified to be in a state wherein driving is possible, the robot 100 may release the setting of an area wherein re-entry is impossible.

According to the aforementioned embodiment, when a trapped situation in an obstacle-dense area occurs, operation efficiency can be increased by selectively using 3D point cloud information.

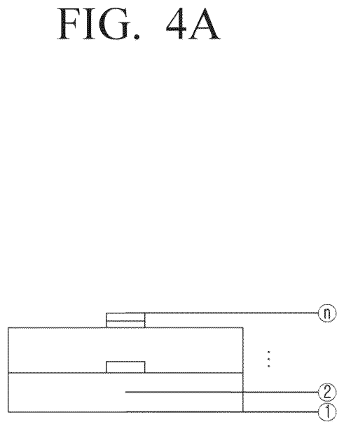

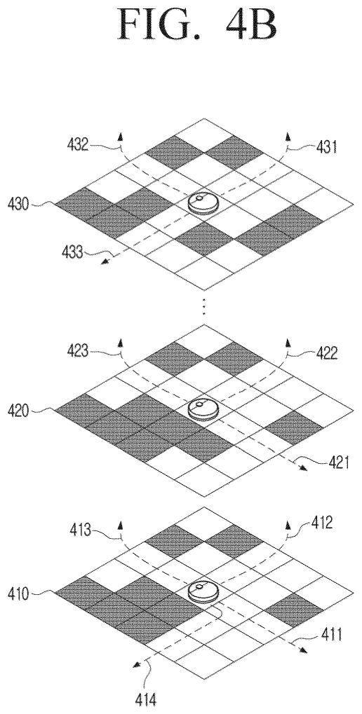

FIG. 4A and FIG. 4B are diagrams for illustrating a method of identifying escape routes for each of a plurality of planes according to an embodiment.

According to an embodiment, if it is identified that a trapped situation occurred in an obstacle-dense area, the robot 100 may divide the accumulated 3D point cloud information into a plurality of planes based on the height of the robot 100. According to an embodiment, the robot 100 may identify escape routes for each plane based on the accumulated 3D point cloud information.

According to an embodiment, the robot 100 may equally divide the height of the robot 100 by a specific interval, and identify the equally divided heights \textcircled{1}, \textcircled{2}, ... as illustrated in FIG. 4A. The height of the robot 100 may be divided by different intervals but not a specific interval, and heights corresponding to each of the plurality of planes may be identified.

According to an embodiment, the robot 100 may divide the accumulated 3D point cloud information into a plurality of planes 410, 420 ..., 430 corresponding to the equally divided heights \textcircled{1}, \textcircled{2}, ... as illustrated in FIG. 4B.

According to an embodiment, the robot 100 may identify escape routes for each plane based on the point cloud information corresponding to each of the plurality of planes 410, 420 ..., 430. For example, the robot 100 may identify escape routes by determining a movable direction by analyzing obstacle distribution based on the point cloud information corresponding to each of the plurality of planes 410, 420 ..., 430.

For example, the robot 100 may identify the first to fourth escape routes 411, 412, 413, 414 based on the first point cloud information corresponding to the first plane 410. For example, the robot 100 may identify the fifth to seventh escape routes 421, 422, 423 based on the second point cloud information corresponding to the second plane 420. For example, the robot 100 may identify the eighth to tenth escape routes 431, 432, 433 based on the nth point cloud information corresponding to the nth plane 430.

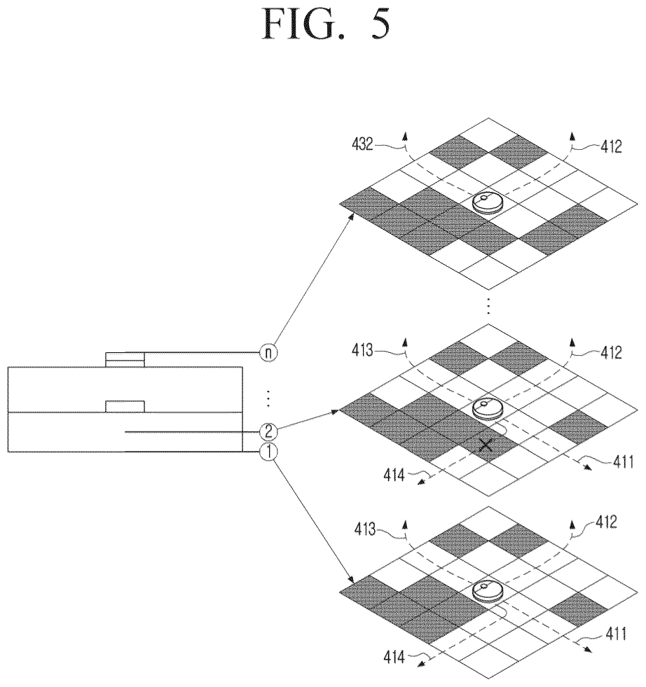

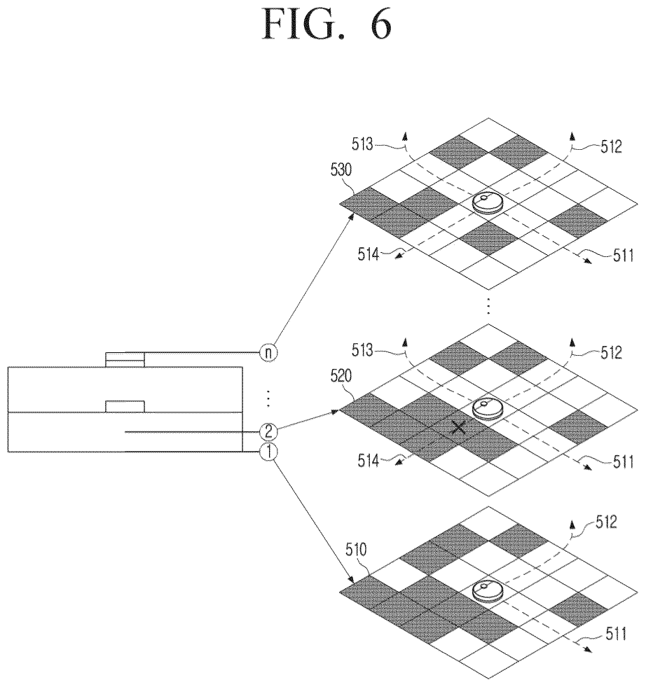

FIG. 5 and FIG. 6 are diagrams for illustrating a method of identifying a final escape route based on escape routes for each plane according to an embodiment.

According to an embodiment, the robot 100 may identify at least one final escape route by sequentially eliminating escape routes for each of the plurality of planes. For example, the robot 100 may identify a final escape route by sequentially identifying escape routes for each of the plurality of planes in one direction, and eliminating escape routes that do not coincide. For example, the one direction may include at least one of an upper direction from the lowermost plane or a lower direction from the uppermost plane among the plurality of planes.

According to the embodiment illustrated in FIG. 5, the robot 100 according to an embodiment may update the escape routes by eliminating one escape route 414 that does not coincide with the three escape routes identified in the next plane in the upper direction among the four escape routes 411, 412, 413, 414 identified in the lowermost plane among the plurality of planes. For example, the updated escape routes may include the three escape routes 411, 412, 413. The robot 100 according to an embodiment may finally update the escape routes by sequentially proceeding with such elimination of escape routes for each of the plurality of planes to the uppermost plane. For example, the finally updated escape routes may include two escape routes 411, 412.

According to the embodiment illustrated in FIG. 6, the robot 100 according to an embodiment may update the escape routes by eliminating one escape route 514 that does not coincide with the three escape routes identified in the next plane in the lower direction among the four escape routes 511, 512, 513, 514 identified in the uppermost plane among the plurality of planes 510, 520, and 530. For example, the updated escape routes may include the three escape routes 511, 512, 513. The robot 100 according to an embodiment may finally update the escape routes by sequentially proceeding with such elimination of escape routes for each of the plurality of planes to the lowermost plane. For example, the finally updated escape routes may include two escape routes 511, 512.

According to an embodiment, when a plurality of escape routes are finally identified, the robot 100 may identify priorities of the plurality of escape routes based on at least one of a location of a target point, an escape distance, or an escape time. According to an embodiment, the robot 100 may identify priorities of the plurality of escape routes based on at least one of a location of a target point, an escape distance, or an escape time according to service types. In this case, when the priorities of the plurality of escape routes are identified, the robot 100 may perform escape driving according to an escape route having the highest priority among the plurality of escape routes.

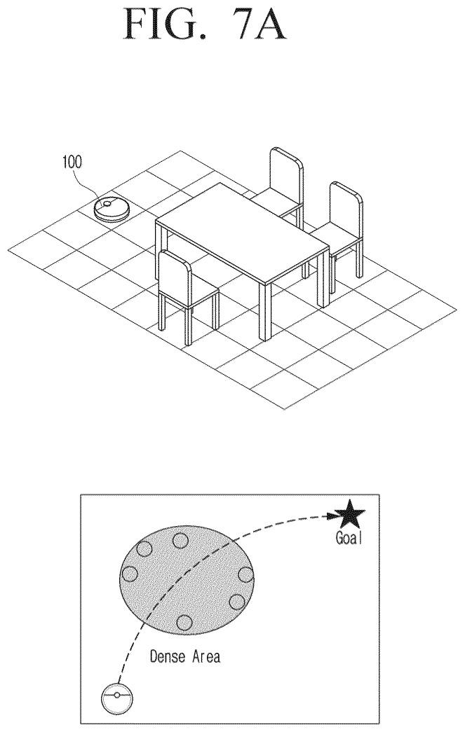

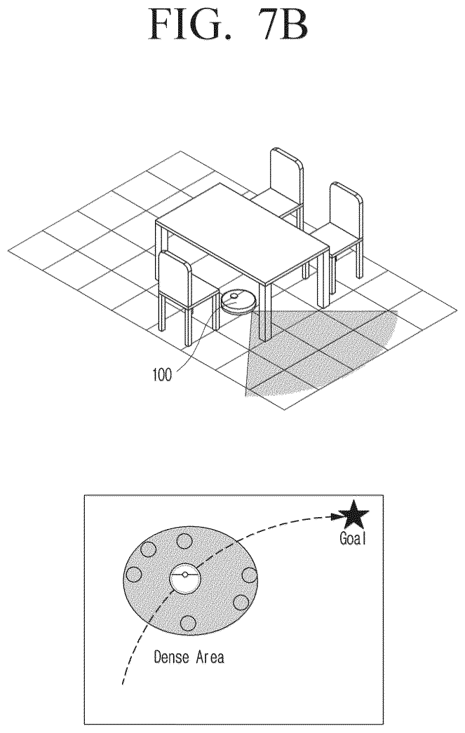

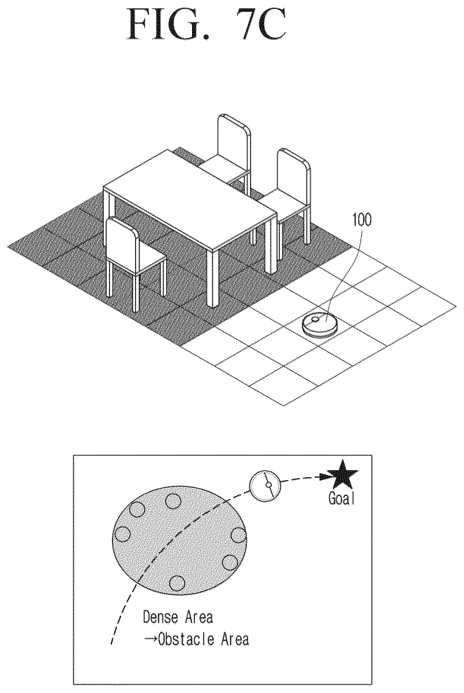

FIG. 7A to FIG. 7C are diagrams for illustrating a scenario after escaping an obstacle-dense area according to an embodiment.

According to FIG. 7A, if an obstacle-dense area (e.g., a dense area) is identified, the robot 100 may start accumulating 3D point cloud information.

According to FIG. 7B, if the robot 100 identifies that it is trapped in an obstacle-dense area, it may additionally accumulate the 3D point cloud information obtained by performing a primitive motion. Afterwards, the robot 100 may escape the obstacle-dense area according to planning of a sequential escape route for each plane based on the accumulated 3D point cloud information.

According to FIG. 7C, the robot 100 may set the obstacle-dense area as an area wherein re-entry is impossible on the map based on the location information of the obstacle-dense area after escaping the obstacle-dense area. For example, the robot 100 may exclude the obstacle-dense area set as an area wherein re-entry is impossible from a driving path. For example, if obstacles in the obstacle-dense area are removed afterwards, and the area is identified to be in a state wherein driving is possible, the robot 100 may release the setting of an area wherein re-entry is impossible.

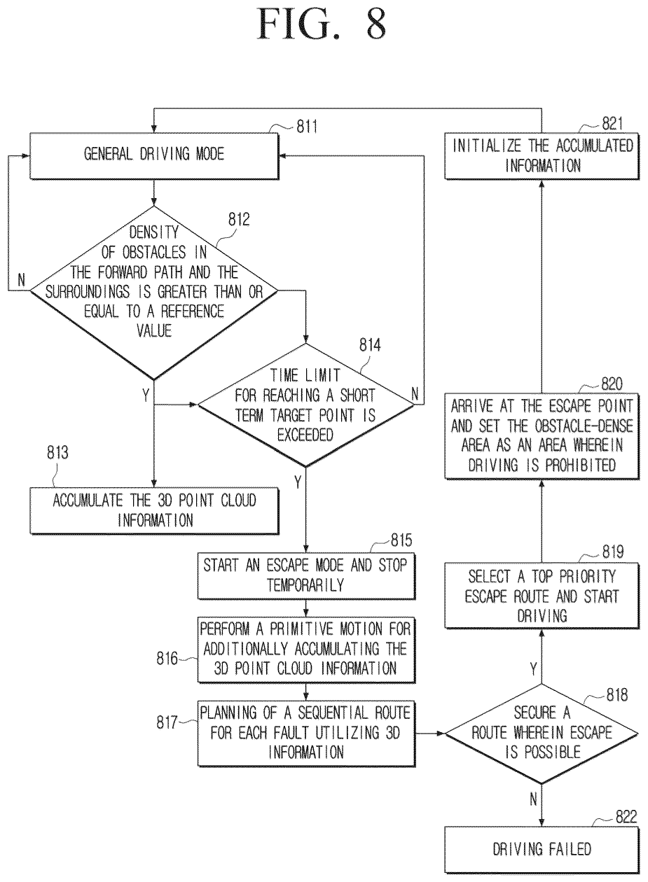

FIG. 8 is a flow chart for illustrating an example of a method of escaping obstacles according to an embodiment.

In the embodiments below, each operation may be performed sequentially, but they are not necessarily performed sequentially. For example, the order of each operation may be changed, or at least two operations may be performed in parallel.

According to FIG. 8, in the operation 811, the robot 100 according to an embodiment may drive in a space in a general driving mode based on an SLAM technology. For example, a driving space of the robot 100 may include various spaces such as at least one of a home, an office, a store, etc. For example, the general driving mode may be a mode wherein the robot 100 drives based on sensing data obtained through the LiDAR sensor.

In the operation 812, the robot 100 according to an embodiment may identify whether the density of obstacles in the forward path and the surroundings is greater than or equal to a reference value. According to an embodiment, the robot 100 may determine whether an obstacle-dense area exists based on at least one of point density or an occupancy grid map of cloud point data obtained through the LiDAR sensor.

If the density of obstacles in the forward path and the surroundings is identified to be greater than or equal to the reference value in the operation 812:Y, the robot 100 according to an embodiment may start accumulating 3D point cloud information in the operation 813.

In the operation 814, the robot 100 according to an embodiment may identify whether a time limit for reaching a short term target point is exceeded. The time limit for reaching a short term target point may be a time limit that was set for the robot 100 to reach a specific target point. For example, an appropriate time limit may be set based on a distance to a target point and the expected moving speed. For example, if the robot 100 needs to move 2m to a target point and the average speed of the robot 100 is 0.3m/s, a time limit of about 6-8 seconds may be set.

If the time limit for reaching the short term target point is exceeded in the operation 814:Y, the robot 100 according to an embodiment may determine that a trapped situation occurred and start an escape mode in the operation 815. For example, the robot 100 may start the escape mode and stop temporarily.

In the operation 816, the robot 100 according to an embodiment may start a primitive motion for accumulating the 3D point cloud information. According to an embodiment, the primitive motion may include at least one of a rotating-in-place motion or a forward-backward moving motion.

In the operation 817, the robot 100 according to an embodiment may perform planning of a sequential route for each plane using 3D information, e.g., the accumulated 3D point cloud information. For example, the robot 100 may identify an escape route by determining a movable direction by analyzing obstacle distribution based on the 3D cloud information corresponding to each of the plurality of planes.

In the operation 818, the robot 100 according to an embodiment may identify whether an escape route is secured based on the planning of a sequential route for each plane.

If an escape route is secured in the operation 818:Y, the robot 100 according to an embodiment may select a top priority escape route and start driving in the operation 819. According to an embodiment, if a plurality of escape routes are finally identified, the robot 100 may identify priorities of the plurality of escape routes based on at least one of a location of a target point, an escape distance, or an escape time.

In the operation 820, the robot 100 according to an embodiment may arrive at the escape point and set the obstacle-dense area as an area wherein driving is prohibited.

In the operation 821, the robot 100 according to an embodiment may initialize the accumulated 3D point cloud information. For example, the robot 100 may initialize the accumulated 3D point cloud information by deleting the 3D point cloud information that was accumulatively stored in the memory 120. Accordingly, memory efficiency can be secured.

If an escape route is secured in the operation 818:N, the robot 100 according to an embodiment may identify that it failed in driving in the operation 822. According to an embodiment, the robot 100 may provide a feedback notifying failure of driving. For example, a feedback notifying failure of driving may be provided through at least one of a voice, a mobile app, a status light, or a sound warning.

According to the aforementioned various embodiments, when a trapped situation in an obstacle-dense area occurs, the robot 100 identifies a final escape route by sequentially eliminating escape routes for each plane by dividing 3D point cloud information for each plane, and thus operation efficiency can be increased.

Methods according to the aforementioned various embodiments of the disclosure may be implemented in forms of applications that can be installed on conventional robots. Alternatively, the methods according to the aforementioned various embodiments of the disclosure may be performed by using an artificial neural network based on deep learning (or a deep artificial neural network), i.e., a learning network model.

Also, the methods according to the aforementioned various embodiment of the disclosure may be implemented just with software upgrade, or hardware upgrade for a conventional robot.

In addition, the aforementioned various embodiments of the disclosure may also be performed through an embedded server provided on a robot, or an external server of a robot.

Further, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include a robot according to the aforementioned embodiments (e.g.: a robot A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, and does not distinguish whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store®). In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while certain embodiments of the disclosure have been shown and described, the disclosure is not limited to the aforementioned embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. A robot comprising:
a sensor;
a driver;
memory storing instructions; and
at least one processor comprising processing circuitry,
wherein the instructions, when executed by the at least one processor individually or collectively, cause the robot to:
based on identifying an obstacle-dense area within a forward path based on first sensing data obtained through the sensor while driving in a space, obtain three-dimensional (3D) point cloud information based on second sensing data obtained through the sensor,
based on identifying that the robot is unable to navigate in the obstacle-dense area, divide the 3D point cloud information into a plurality of planes based on a height of the robot, and identify one or more escape routes for each of the plurality of planes,
identify at least one final escape route, from among the one or more escape routes, by eliminating escape routes from the one or more escape routes that are blocked in any of the plurality of planes, and
control the driver to drive based on the at least one final escape route.

2. The robot of claim 1, wherein the instructions, when executed by the at least one processor individually or collectively, further cause the robot to:
equally divide the height of the robot by a specific interval, and
divide the 3D point cloud information into the plurality of planes corresponding to the equally divided heights.

3. The robot of claim 1, wherein the instructions, when executed by the at least one processor individually or collectively, further cause the robot to:
based on identifying that the robot is unable to navigate in the obstacle-dense area, obtain the second sensing data through the sensor by performing a primitive motion, and
obtain the 3D point cloud information based on the second sensing data.

4. The robot of claim 3, wherein the primitive motion comprises at least one of a rotating-in-place motion or a forward-backward moving motion.

5. The robot of claim 1, wherein the instructions, when executed by the at least one processor individually or collectively, further cause the robot to eliminate escape routes from the one or more escape routes by:
identifying at least one first escape route on a lowermost plane among the plurality of planes, and
updating the at least one first escape route by identifying at least one second escape route on a plane directly above the lowermost plane, among the plurality of planes and eliminating from the at least one first escape route an escape route that does not coincide with the at least one second escape route, and
wherein the instructions, when executed by the at least one processor individually or collectively, further cause the robot to control the driver to drive based on the updated first escape route.

6. The robot of claim 1, wherein the instructions, when executed by the at least one processor individually or collectively, further cause the robot to eliminate escape routes from the one or more escape routes by:
identifying at least one third escape route on an uppermost plane among the plurality of planes, and
updating the at least one third escape route by identifying at least one fourth escape route on a plane directly below the uppermost plane, among the plurality of planes, and eliminating from the at least one third escape route an escape route that does not coincide with the at least one fourth escape route, and
wherein the instructions, when executed by the at least one processor individually or collectively, further cause the robot to control the driver to drive based on the updated third escape route.

7. The robot of claim 1, wherein the instructions, when executed by the at least one processor individually or collectively, further cause the robot to:
based on identifying the at least one final escape route, identify a priority of each of the at least one final escape route based on at least one of a location of a target point, an escape distance, or an escape time, and
control the driver to drive according to the at least one final escape route with the highest identified priority.

8. The robot of claim 1, wherein the instructions, when executed by the at least one processor individually or collectively, further cause the robot to:
based on the robot failing to reach a short term target point within a specific time after entering the obstacle-dense area or the robot remaining within a specific area during a predetermined time or longer, identify that the robot is unable to navigate in the obstacle-dense area.

9. The robot of claim 1, wherein the instructions, when executed by the at least one processor individually or collectively, further cause the robot to:
after escaping the obstacle-dense area, set the obstacle-dense area as an area where re-entry is prohibited.

10. The robot of claim 1, wherein the instructions, when executed by the at least one processor individually or collectively, further cause the robot to:
initialize the accumulated 3D point cloud information after escaping the obstacle-dense area.

11. A method of controlling a robot, the method comprising:
based on identifying an obstacle-dense area within a forward path based on first sensing data obtained while driving in a space, obtaining three-dimensional (3D) point cloud information based on second sensing data;
based on identifying that the robot is unable to navigate in the obstacle-dense area, dividing the 3D point cloud information into a plurality of planes based on a height of the robot, and identifying one or more escape routes for each of the plurality of planes;
identifying at least one final escape route, from among the one or more escape routes, by eliminating escape routes from the one or more escape routes that are blocked in any of the plurality of planes; and
controlling a driver of the robot to drive based on the at least one final escape route.

12. The method of claim 11, wherein the identifying the one or more escape routes comprises:
equally dividing the height of the robot by a specific interval; and
dividing the 3D point cloud information into the plurality of planes corresponding to the equally divided heights.

13. The method of claim 11, further comprising:
based on identifying that the robot is unable to navigate in the obstacle-dense area, obtaining the second sensing data by performing a primitive motion; and
obtaining the 3D point cloud information based on the second sensing data.

14. The method of claim 13, wherein the primitive motion comprises at least one of a rotating-in-place motion or a forward-backward moving motion.

15. The method of claim 11, further comprising:
based on identifying the at least one final escape route, identifying a priority of each of the at least one final escape route based on at least one of a location of a target point, an escape distance, or an escape time, and
controlling the driver to drive according to the at least one final escape route with the highest identified priority.

16. The method of claim 11, further comprising:
based on the robot failing to reach a short term target point within a specific time after entering the obstacle-dense area or the robot remaining within a specific area during a predetermined time or longer, identifying that the robot is unable to navigate in the obstacle-dense area.

17. The method of claim 11, wherein the obtaining the 3D point cloud information comprises:
starting accumulating 3D point cloud information in the memory on the basis of second sensing data.

18. The method of claim 11, further comprising:
initializing the accumulated 3D point cloud information after escaping the obstacle-dense area.

19. The method of claim 11, wherein the identifying at least one final escape route comprises:
identifying at least one first escape route on a lowermost plane among the plurality of planes; and
updating the at least one first escape route by identifying at least one second escape route on a plane directly above the lowermost plane, among the plurality of planes and eliminating from the at least one first escape route an escape route that does not coincide with the at least one second escape route, and
wherein the controlling the driver of the robot to drive based on the at least one final escape route comprises:
controlling the driver to drive based on the updated first escape route.

20. A robot comprising:
a sensor;
a driver;
memory storing instructions; and
at least one processor configured to execute the instructions,
wherein the instructions, when executed by the at least one processor individually or collectively, cause the robot to:
identifying an area within a forward path of the robot as an obstacle-dense area based on first sensing data obtained through the sensor while driving in a space, wherein the area includes a number of obstacles within a predetermined distance of one another and the number of obstacles exceeds a predetermined threshold,
based on identifying the obstacle-dense area, obtain three-dimensional (3D) point cloud information based on second sensing data obtained through the sensor,
based on identifying that a maneuverability of the robot within the obstacle-dense area is less than a predetermined threshold, divide the 3D point cloud information into a plurality of planes based on a height of the robot, and identify one or more escape routes for each of the plurality of planes,
identify at least final one escape route, from among the one or more escape routes, by eliminating escape routes from the one or more escape routes that are blocked in any of the plurality of planes, and
control the driver to drive based on the at least one final escape route.
